(19) United States
(12) Patent Application Publication
(10) Pub. No.: US 2026/0043385 A1
(43) Pub. Date: Feb. 12, 2026

(54) WATER-DRAWING STRUCTURE FOR OCEAN ENERGY GENERATOR

(71) Applicant: Ho-Yuan Hsieh, Taichung City (TW)

(72) Inventor: Ho-Yuan Hsieh, Taichung City (TW)

(21) Appl. No.: 19/271,817

(22) Filed: Jul. 17, 2025

(30) Foreign Application Priority Data
Aug. 6, 2024 (TW) 113129379

(51) Int. Cl. F03B 13/18; F03B 13/06

(52) U.S. Cl. CPC F03B 13/189; F03B 13/06; F05B 2260/50

(57) ABSTRACT

A water-drawing structure for an ocean energy generator includes a sea-water collection tank with multiple locating posts at its bottom. An intake conduit includes a check valve connected to the tank, and a water-drawing assembly connected to the intake conduit. A floating element on the water surface is connected to a linkage system comprising a main linkage, a piston rod and a floating element linkage. The main linkage pivots on a pillar at one end and is connected to the floating element linkage at the other end. The piston rod is connected between the main linkage and the water-drawing assembly. A counterweight is connected to the main linkage where it connects to the floating element linkage. One pillar has two positioning feet between which the main linkage passes. As waves cause the floating element, the linkage system drives the water-drawing assembly to pump seawater efficiently for power generation.

### BACKGROUND OF THE INVENTION

### 1. Fields of the invention

The present invention relates to a water-drawing structure for an ocean energy generator, which is a device that uses ocean waves as kinetic energy to draw water, serving as a water pump for the operation of ocean energy generation equipment.

### 2. Descriptions of Related Art

Current mainstream power generation methods cause significant pollution to the Earth's environment. For example, nuclear power generation produces large amounts of nuclear waste, and thermal power generation creates serious air pollution. With the rise of environmental awareness, countries around the world have successively developed green energy to replace existing power generation methods, including solar energy, wind power, hydropower, and various other green energy sources, hoping that green energy technology will become the main power generation technology.

Among green energy sources, hydropower is a project with considerable potential. Hydropower mainly relies on the water flow created by the height differences of rivers and mountains to wash the water wheels of hydroelectric generators. After being washed, the rotational kinetic energy produced by the water wheel can be converted into electricity through equipment, thus achieving the effect of hydropower generation. However, traditional hydropower plants have very strict requirements for installation locations. In Taiwan, for instance, most rivers are short and the geology is fragile, so most locations suitable for hydropower plants already have reservoirs built. For these reservoirs, the priority of supplying domestic water is greater than power generation, so most hydropower plants are unable to operate for the majority of the time.

In view of the aforementioned problems, people have further developed ocean energy power generation based on the principles of hydroelectric power. However, the current mainstream ocean energy power generation mostly relies on the water level differences produced by ocean tidal changes to generate kinetic energy, but the time for a complete tidal cycle in the ocean is too long, so the efficiency is not very good. In light of this, it is necessary to further improve the efficiency of today's ocean energy power generation.

The present invention intends to provide a water-drawing structure for an ocean energy generator to eliminate shortcomings mentioned above.

### SUMMARY OF THE INVENTION

The present invention relates to a water-drawing structure for an ocean energy generator, and comprises: a sea-water collection tank; a plurality of locating posts respectively disposed at a bottom of the sea-water collection tank. An intake conduit having a check valve disposed therein, one end of the intake conduit being fluidly connected to the sea-water collection tank. A water-drawing assembly has one end thereof connected to the intake conduit. A floating element floats on the water surface connects to a linkage system which comprises a main linkage, a piston rod and a floating element linkage. A first end of the main linkage is pivotally installed on one of the locating posts, and a second end of the main linkage is pivotally connected to a first end of the floating element linkage. A second end of the floating element linkage is pivotally connected to the floating element. A first end of the piston rod is connected to the water-drawing assembly, and a second end of the piston rod pivotally connected to the main linkage. A counterweight is disposed on the second end of the main linkage where the floating element linkage is pivotally connected. One of the pluralities of locating posts includes two positioning feet, and the main linkage passes between the two positioning feet.

The present invention is a water-drawing structure for an ocean energy generator. In practical application, each locating posts is fixed to the seabed, while the floating element floats on the sea surface. As the ocean surface waves rise and fall, the combination of the floating element and the counterweight can drive the main linkage to swing up and down, thereby driving the piston member to extend and retract relative to the outer cylinder body, repeatedly sending seawater through the intake conduit to the sea-water collection tank. Subsequently, the seawater from the sea-water collection tank continuously flows toward the power generation water wheel to achieve the purpose of power generation. The present invention enables the ocean energy generator to continuously draw seawater for power generation by relying solely on ocean waves. Since the ocean only needs wind blowing across it to generate waves, compared to the slow tidal changes, the power generation efficiency is superior, effectively improving the previous problem of poor efficiency in ocean energy power generation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1A is a schematic diagram of the main linkage in its upward swing position;

FIG. 1B is an enlarged partial view of FIG. 1;

FIG. 2A is a schematic diagram of the main linkage in its downward swing position;

FIG. 2B is an enlarged partial view of FIG. 2;

FIG. 3 is a schematic diagram of the main linkage passing between the two positioning feet;

FIG. 4 is a schematic diagram of the main linkage in its upward swing position with the second type of water-drawing assembly, and

FIG. 5 is a schematic diagram of the main linkage in its downward swing position with the second type of water-drawing assembly.

### DETAILED DESCRIPTION OF THE PREFERRED EMBODIMENT

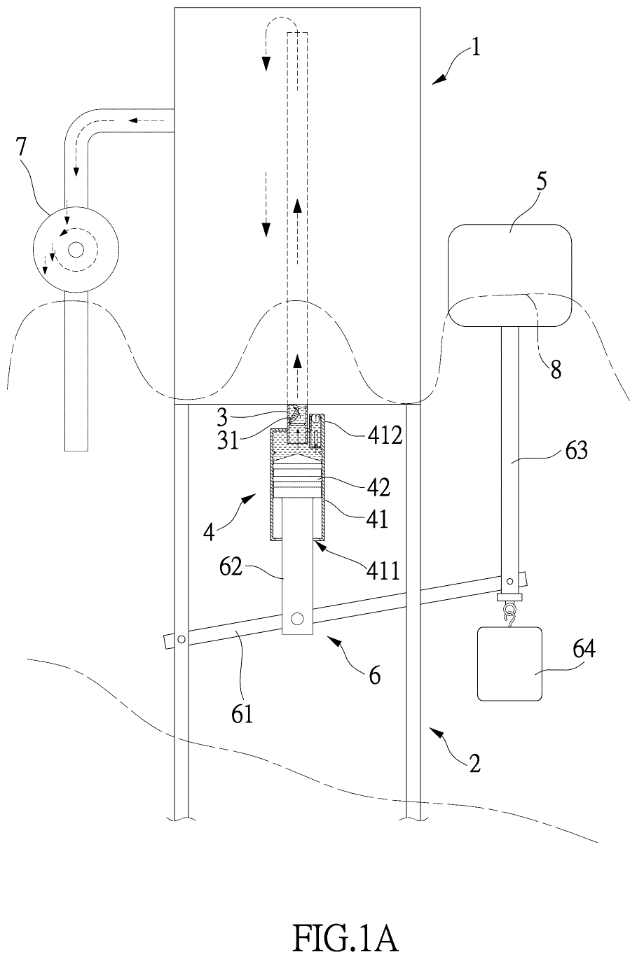

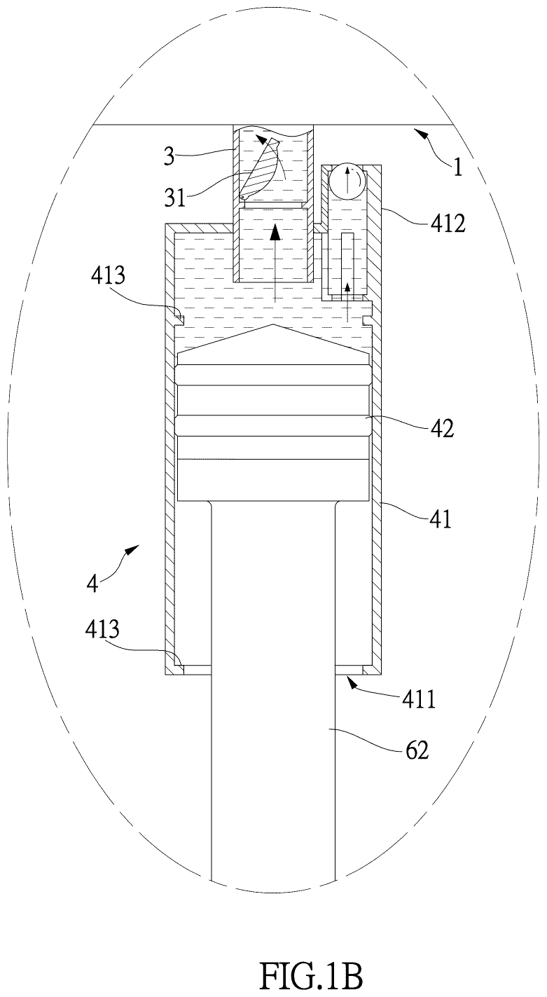

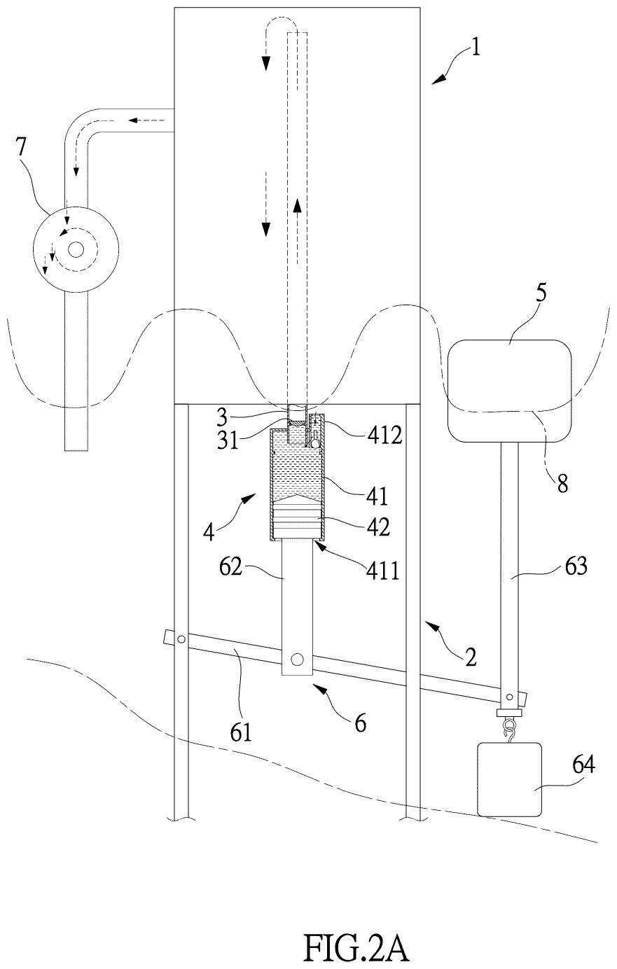

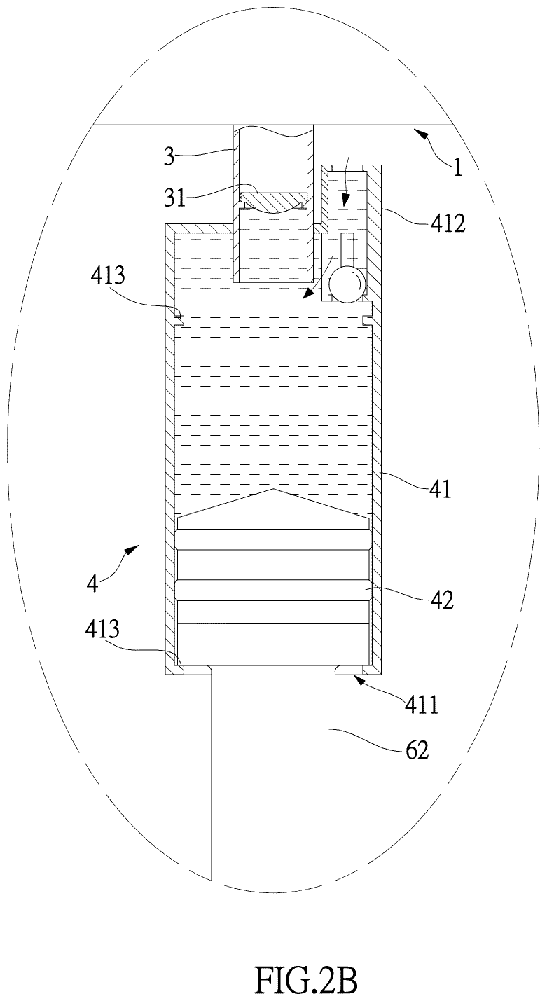

Referring to FIGS. 1A to 2B, the water-drawing structure for an ocean energy generator of the present invention comprises a sea-water collection tank 1 and a plurality of locating posts 2 are respectively disposed at a bottom of the sea-water collection tank 1. An intake conduit 3 has a check valve 31 installed inside thereof. One end of the intake conduit 3 is connected to the sea-water collection tank 1. A water-drawing assembly 4 has one end thereof connected to the intake conduit 3. A floating element 5 floats on water surface and is connected to a linkage system 6. The linkage system 6 comprises a main linkage 61, a piston rod 62 and a floating element linkage 63. A first end of the main linkage 61 is pivotally installed on one of the locating post 2, and a second end of the main linkage 61 is pivotally connected to a first end of the floating element linkage 63, while a second end of the floating element linkage 63 is pivotally connected to the floating element 5. A first end of the piston rod 62 is connected to the water-drawing assembly 4, and a second end of the piston rod 62 is pivotally connected to the main linkage 61.

A counterweight 64 is disposed on the end of the floating element linkage 63 that is pivotally connected to the second end of the main linkage 61.

The water-drawing assembly 4 includes an outer cylinder body 41 and a piston member 42. A first end of the outer cylinder body 41 is connected to the intake conduit 3, and another one of the two ends has an opening 411. The outer cylinder body 41 includes an inlet opening 412 which includes a check valve that allows unidirectional flow. The piston member 42 partially and movably fits tightly into the end of the outer cylinder body 41 with the opening 411. The first end of the piston rod 62 is connected to the piston member 42.

The check function of the inlet opening 412 serves to restrict seawater so that the seawater can only enter the outer cylinder body 41 through the inlet opening 412, while the seawater inside the outer cylinder body 41 cannot flow out of the outer cylinder body 41 through the inlet opening 412.

As shown in FIG. 1A, in practical application, the sea-water collection tank 1 will be combined with the power generation water wheel 7, while each pillar 2 will be fixed to the seabed, and the floating element 5 will float on the sea surface 8. The main linkage 61 has one end pivotally installed on one of the locating posts 2. Therefore, as the sea surface 8 waves rise and fall, the combination of the floating element 5 and the counterweight 64 can drive the main linkage 61 to swing up and down. For example, as shown in FIG. 1A, when the wave crest causes the sea surface 8 below the floating element 5 to rise, the floating element 5 will rise due to buoyancy, causing the floating element linkage 63 to drive the main linkage 61 upward. The upward movement of the main linkage 61 will drive the piston rod 62 to push upward, thereby causing the piston member 42 to compress upward. In this way, the seawater inside the outer cylinder body 41 will be sent into the intake conduit 3, and the check valve 31 inside the intake conduit 3 can effectively prevent seawater from flowing back into the outer cylinder body 41.

As shown in FIG. 2A, when the wave trough passes beneath the floating element 5, the sea surface 8 below the floating element 5 will descend, and the floating element 5 is no longer supported by buoyancy. At this time, the weight of the counterweight 64 causes the main linkage 61 to swing downward. In this way, the main linkage 61 will pull the piston rod 62 to descend, resulting in the piston member 42 being pulled downward, causing external seawater to flow into the inner part of the outer cylinder body 41 through the inlet opening 412. Thus, from the aforementioned content, it can be understood that the structure of the present invention utilizes wave fluctuations to make the piston member 42 extend and retract relative to the outer cylinder body 41, repeatedly sending seawater to the sea-water collection tank 1 via the intake conduit 3. Subsequently, the seawater from the sea-water collection tank 1 will continuously flow toward the power generation water wheel 7 to achieve the purpose of power generation. The present invention enables the ocean energy generator to continuously draw seawater for power generation by relying solely on ocean waves. Since the ocean only needs wind blowing across it to generate waves, compared to the slow tidal changes, the power generation efficiency is superior, effectively improving the previous problem of poor efficiency in ocean energy power generation. The present invention provides a novel and non-obvious configuration for improving wave-driven seawater pumping efficiency.

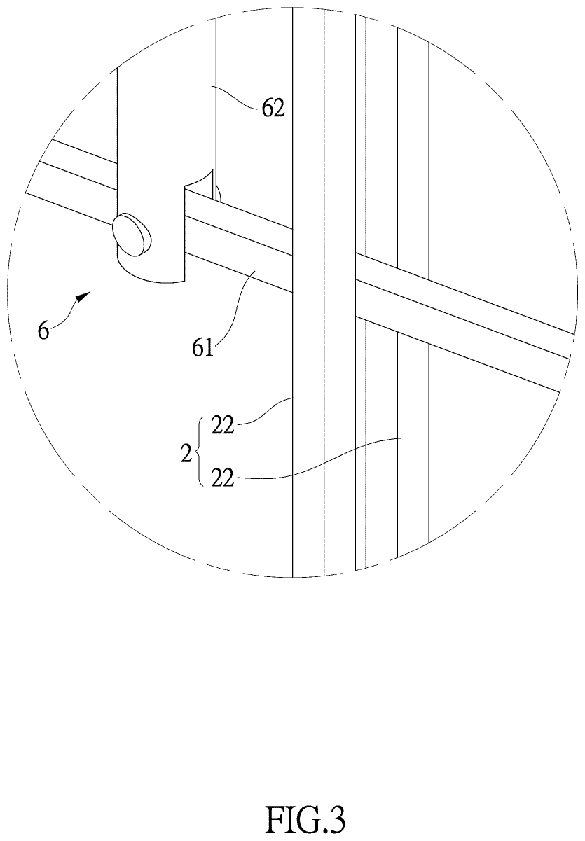

As shown in FIG. 3, one of the pluralities of locating post 2 includes two positioning feet 22, and the main linkage 61 passes between these two positioning feet 22. The purpose of this structure is that the bottom of the main body 21 can limit the rising amplitude of the main linkage 61, thereby stabilizing the main linkage 61.

The connection method between the counterweight 64 and the floating element linkage 63 can be a hook-and-hang connection, to facilitate the replacement and installation of the counterweight 64.

As shown in FIG. 1B, the inner wall of the outer cylinder body 41 includes two ribs 413 (ring-shaped), the two ribs 413 respectively block the displacement path of the piston member 42 when it rises and falls, so as to prevent the piston member 42 from excessive rising or falling during the displacement process.

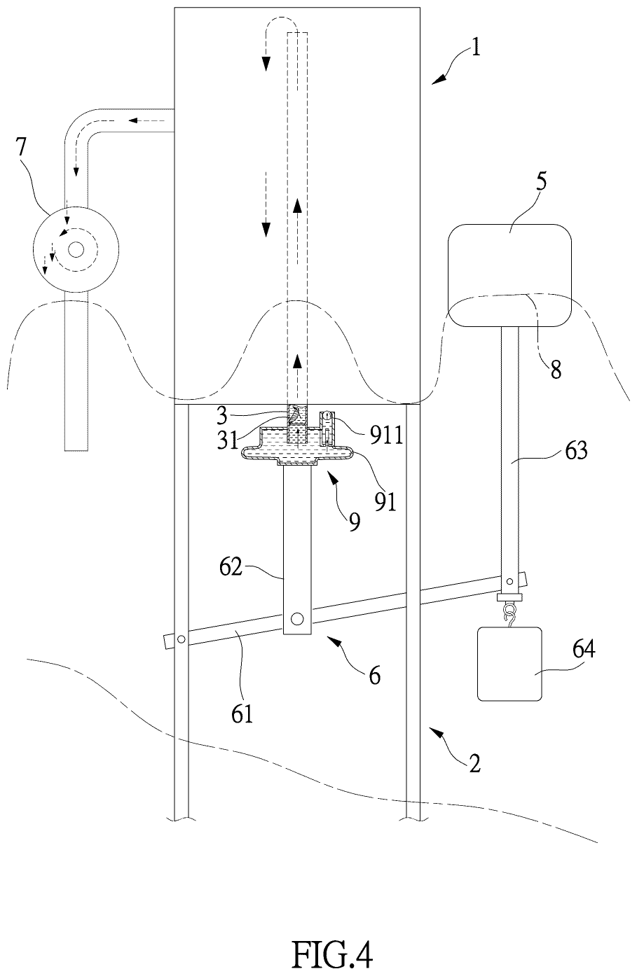

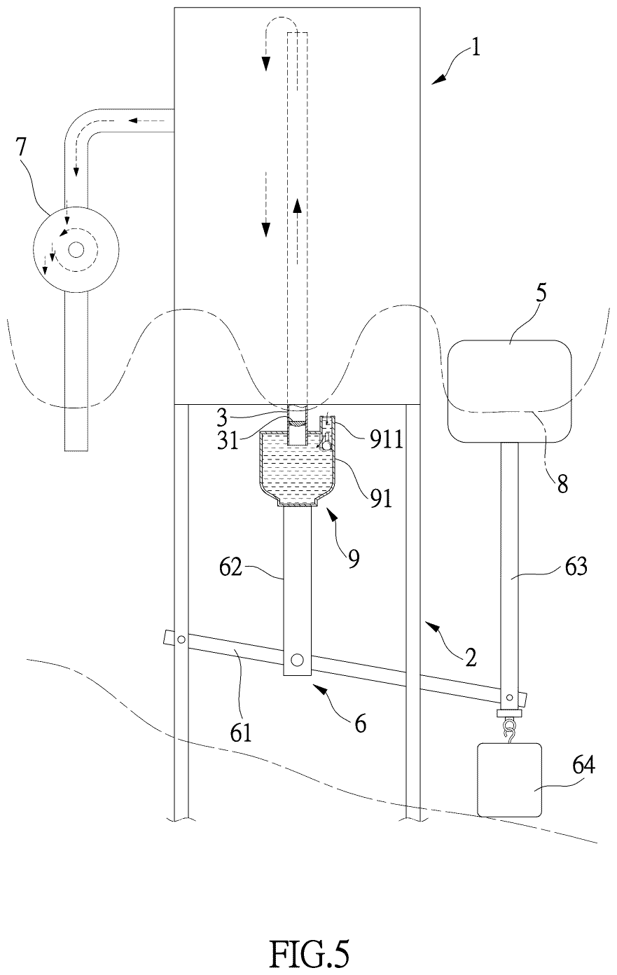

As shown in FIGS. 4 and 5, the water-drawing assembly 9 of the invention has a second embodiment, wherein the water-drawing assembly 9 includes a water-drawing flexible member 91, one end of the water-drawing flexible member 91 is connected to the intake conduit 3 and the other end is connected to the piston rod 62. The water-drawing flexible member 91 is equipped with a inlet opening 911 that includes a check valve that allows unidirectional flow. The difference from the previous embodiment is that the outer cylinder body 41 and the piston member 42 are replaced with the water-drawing flexible member 91.

While we have shown and described the embodiment in accordance with the present invention, it should be clear to those skilled in the art that further embodiments may be made without departing from the scope of the present invention.

What is claimed is:

1. A water-drawing structure for an ocean energy generator, comprising:
a sea-water collection tank ;
a plurality of locating posts respectively disposed at a bottom of the sea-water collection tank ;
an intake conduit having a check valve installed inside thereof, one end of the intake conduit connected to the sea-water collection tank 1;
a water-drawing assembly having one end thereof connected to the intake conduit;
a floating element;
a linkage system comprising a main linkage, a piston rod and a floating element linkage, a first end of the main linkage pivotally installed on one of the locating post, a second end of the main linkage pivotally connected to a first end of the floating element linkage, a second end of the floating element linkage pivotally connected to the floating element, a first end of the piston rod connected to the water-drawing assembly, a second end of the piston rod pivotally connected to the main linkage, and
a counterweight disposed on the end of the floating element linkage that is pivotally connected to the second end of the main linkage, one of the plurality of locating posts including two positioning feet, the main linkage passing between the two positioning feet.

2. The water-drawing structure for an ocean energy generator as claimed in claim 1, wherein the counterweight is connected to the floating element linkage by a hook-and-hang connection.

3. The water-drawing structure for an ocean energy generator as claimed in claim 1, wherein the water-drawing assembly includes an outer cylinder body and a piston member, a first end of the outer cylinder body is connected to the intake conduit, another one of the two ends has an opening, the outer cylinder body includes an inlet opening which includes a check valve that allows unidirectional flow, the piston member partially and movably fits tightly into the end of the outer cylinder body with the opening, the first end of the piston rod is connected to the piston member.

4. The water-drawing structure for an ocean energy generator as claimed in claim 3, wherein an inner wall of the outer cylinder body includes two ribs, the two ribs respectively block a displacement path of the piston member when the piston member rises and falls.

5. The water-drawing structure for an ocean energy generator as claimed in claim 1, wherein the water-drawing assembly includes a water-drawing flexible member, one end of the water-drawing flexible member is connected to the intake conduit, another one of the two ends of the water-drawing flexible member is connected to the piston rod, the water-drawing flexible member includes an inlet opening that includes a check valve that allows unidirectional flow.
